(19) United States
(12) Patent Application Publication
(10) Pub. No.: US 2025/0299610 A1
(43) Pub. Date: Sep. 25, 2025

(54) SIGNAL PROCESSING DEVICE, SIGNAL PROCESSING METHOD, AND DISPLAY

(71) Applicant: JVCKENWOOD CORPORATION, Yokohama-shi (JP)

(72) Inventor: Yuji UCHIYAMA, Yokohama-shi (JP)

(21) Appl. No.: 19/079,415

(22) Filed: Mar. 13, 2025

(30) Foreign Application Priority Data
Mar. 22, 2024 (JP) 2024-046676

(51) Int. Cl. G09G 3/20

(52) U.S. Cl. CPC G09G 3/2007; G09G 2310/066; G09G 2310/08

(57) ABSTRACT

A stepwise waveform generation data generator is configured to generate stepwise waveform generation data having a data value corresponding to each display gradation within each horizontal scanning period, and a time length corresponding to the number of pixels of each of the display gradations for generating a stepwise waveform signal, based on a gradation value of each of the display gradations and start time of the display gradation period for each of the display gradations. A grayscale-transformed video data generator is configured to generate grayscale-transformed video data, which is video data obtained by transforming pixel values of each pixel in the horizontal scanning periods of video data into pixel values that are dispersed so as to correspond to the selection periods corresponding to the display gradations.

### CROSS REFERENCE TO RELATED APPLICATIONS

This application is based upon and claims the benefit of priority under 35U.S.C. § 119 from Japanese Patent Application No. 2024-046676 filed on Mar. 22, 2024, the entire contents of which are incorporated herein by reference.

### BACKGROUND

The present disclosure relates to a signal processing device, a signal processing method, and a display.

A display includes a display device and a signal processing device for processing video data input to the display device. An example of the display device is a liquid crystal device. By driving the display device based on gradation data for each pixel, the display can display an image based on video data in gradation. The display device is provided with analog switches corresponding to the number of pixels in a horizontal direction. The display device turns off the analog switches at a timing when the gradation data of each pixel coincides with a counter value within a horizontal scanning period, and applies a voltage value determined by a ramp waveform signal at the coinciding timing to each pixel.

Japanese Unexamined Patent Application Publication No. 2020-173439 (Patent Literature 1) discloses that, when many analog switches of pixels having the same gradation are simultaneously turned off within a horizontal scanning period, a large load fluctuation occurs in a ramp waveform signal and ringing occurs. Patent Literature 1 discloses a method for suppressing deterioration of gradation reproducibility due to ringing.

### SUMMARY

In recent years, the frame rate of video data has been increasing. One horizontal scanning period at a frame rate of 120 Hz is ½ of one horizontal scanning period at a frame rate of 60 Hz. If the number of analog switches simultaneously turned off is the same, a ringing period during which ringing occurs in the ramp waveform signal is the same when the display displays video data at a frame rate of 60 Hz and when the display displays video data at t a frame rate of 120 Hz. Therefore, as the frame rate of video data increases, the ringing period becomes relatively longer with respect to the horizontal scanning period, and the deterioration of gradation reproducibility caused by ringing becomes a more serious problem.

The method for suppressing deterioration of gradation reproducibility caused by ringing described in Patent Literature 1 is insufficient for suppressing the deterioration of gradation reproducibility during displaying video data at a high frame rate. It is required to further improve gradation reproducibility by suppressing occurrence of ringing itself.

A first aspect of one or more embodiments provides a signal processing device including: a grayscale histogram generator configured to generate a grayscale histogram indicating the number of pixels for each display gradation in horizontal scanning periods of input video data; a non-selection period setting unit configured to set a non-selection period corresponding to the display gradations in a stepwise waveform signal, which is an analog signal with a stepwise increase in voltage value in accordance with the display gradations present within the horizontal scanning periods, based on settling time from a start time of each step when the voltage value corresponding to the display gradations increases stepwise until the voltage value of each step falls within an allowable range of a target value; a selection period setting unit configured to set a selection period corresponding to the display gradations following the non-selection period, based on the grayscale histogram, a non-selection sum period obtained by summing up the non-selection periods corresponding to the display gradations in the horizontal scanning periods, and a selection sum period obtained by subtracting the non-selection sum period from the total number of gradations of the video data; a display gradation period start time acquisition unit configured to acquire a start time of a display gradation period which is a period obtained by combining the non-selection period and the selection period, for each of the display gradations based on the display gradation period; a stepwise waveform generation data generator configured to generate stepwise waveform generation data for generating the stepwise waveform signal, based on gradation values of the display gradations and start time of the display gradation period for each of the display gradations; and a grayscale-transformed video data generator configured to generate grayscale-transformed video data, which is video data obtained by transforming pixel values of each pixel in the horizontal scanning periods of the video data into pixel values that are dispersed so as to correspond to the selection periods corresponding to the display gradations.

A second aspect of one or more embodiments provides a display including: the above-described signal processing device; a stepwise waveform signal generation circuit configured to generate the stepwise waveform signal by converting the stepwise waveform generation data into an analog signal; and a display device having a plurality of pixels and configured to generate a gradation drive voltage for each of the pixels, based on the grayscale-transformed video data and the stepwise waveform signal.

A third aspect of one or more embodiments provides a signal processing method including: generating a grayscale histogram indicating the number of pixels for each display gradation in horizontal scanning periods of input video data; setting a non-selection period corresponding to the display gradations in a stepwise waveform signal, which is an analog signal with a stepwise increase in voltage value in accordance with display gradations present within the horizontal scanning periods, based on settling time from a start time of each step when the voltage value corresponding to the display gradations increases stepwise until the voltage value of each step falls within an allowable range of a target value; setting a selection period corresponding to the display gradations following the non-selection period, based on the grayscale histogram, a non-selection sum period obtained by summing up the non-selection periods corresponding to the display gradations in the horizontal scanning periods, and a selection sum period obtained by subtracting the non-selection sum period from the total number of gradations of the video data; acquiring a start time of a display gradation period which is a period obtained by combining the non-selection period and the selection period, for each of the display gradations based on the display gradation period; and generating grayscale-transformed video data, which is video data obtained by transforming pixel values of each pixel in the horizontal scanning periods of the video data into pixel values that are dispersed so as to correspond to the selection periods corresponding to the display gradations.

### BRIEF DESCRIPTION OF THE DRAWINGS

FIG. 1 is a configuration diagram illustrating a display according to one or more embodiments.

FIG. 2 is a time chart illustrating a schematic operation of a display according to one or more embodiments.

FIG. 3A is a waveform diagram illustrating stepwise waveform generation data and a stepwise waveform signal used by the display according to one or more embodiments in determining a voltage value to be applied to each pixel.

FIG. 3B is a waveform diagram illustrating ramp waveform control data and a ramp waveform signal used by a general display in determining a voltage value to be applied to each pixel.

FIG. 4 is a block diagram illustrating a signal processing device according to one or more embodiments.

FIG. 5 is a diagram illustrating a video format of video data input to the signal processing device according to one or more embodiments.

FIG. 6 is a diagram illustrating an example of a frame of video data input to the signal processing device according to one or more embodiments.

FIG. 7 is a diagram illustrating a grayscale histogram generated at line j of the frame illustrated in FIG. 6 by a grayscale histogram generator included in the signal processing device according to one or more embodiments.

FIG. 8 is a waveform diagram illustrating a stepwise waveform signal generated based on the grayscale histogram illustrated in FIG. 7.

FIG. 9 is a characteristic diagram illustrating a relationship between an amount of change in the stepwise waveform generation data and the time until the voltage value of the stepwise waveform signal stabilizes.

FIG. 10 is a characteristic diagram illustrating a relationship between the amount of change in the stepwise waveform generation data and settling time.

FIG. 11 is a diagram illustrating operation of the grayscale-transformed video data generator included in the signal processing device according to one or more embodiments in association with the stepwise waveform generation data generated on the basis of the grayscale histogram illustrated in FIG. 7.

FIG. 12 is a diagram illustrating how the grayscale-transformed video data generator transforms video data to generate grayscale-transformed video data.

### DETAILED DESCRIPTION

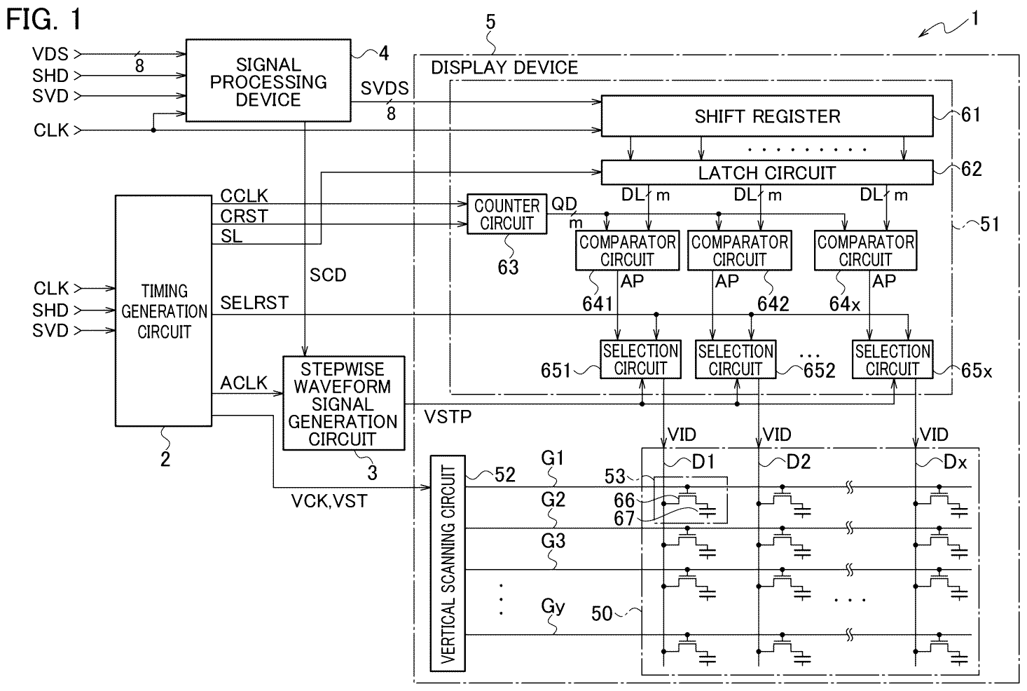

A display according to one or more embodiments will be described with reference to FIG. 1. A display 1 according to one or more embodiments includes a timing generation circuit 2, a stepwise waveform signal generation circuit 3, a signal processing device 4, and a display device 5. Typically, the display device 5 is a liquid crystal device, and the display 1 is a liquid crystal display. However, the display device 5 is not limited to a liquid crystal device, and the display 1 is not limited to a liquid crystal display. The display device 5 includes a display pixel section 50, a horizontal scanning circuit 51, and a vertical scanning circuit 52. The display pixel section 50 includes a plurality (x×y) of pixels 53 arranged in a matrix at each intersection of a plurality (x) of column data lines D (D1 to Dx) arranged in a horizontal direction and a plurality (y) of row scanning lines G (G1 to Gy) arranged in a vertical direction.

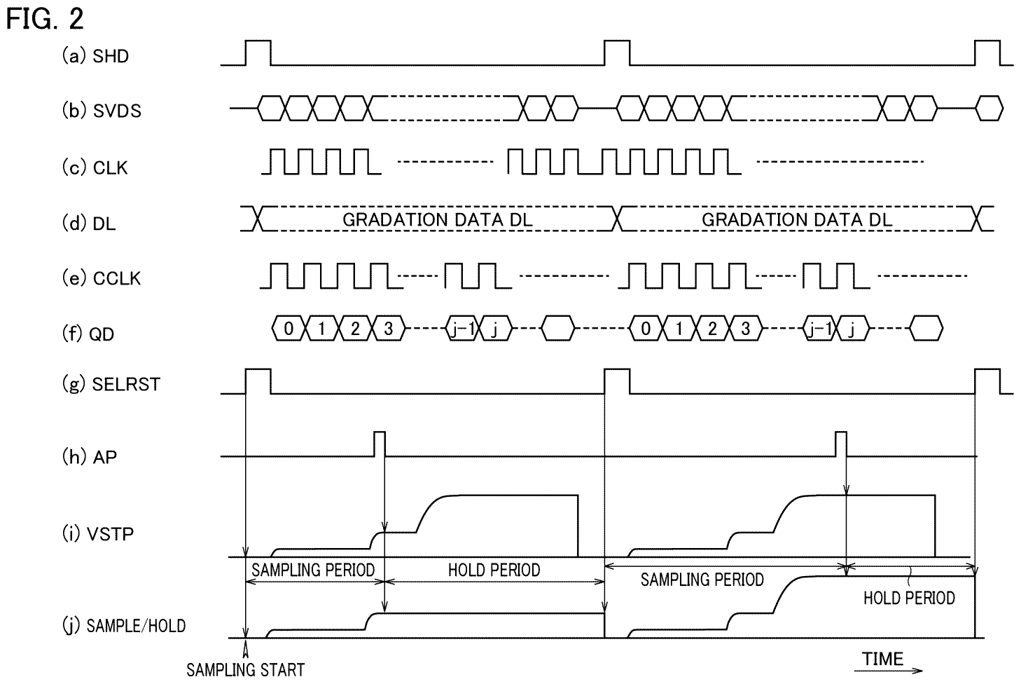

A time chart in FIG. 2 illustrates a schematic operation of the display 1. In FIG. 2, (a) denotes a horizontal synchronization signal SHD input to the signal processing device 4, (b) denotes grayscale-transformed video data SVDS obtained by grayscale transformation of video data VDS input to the signal processing device 4, (c) denotes a clock signal CLK input to the signal processing device 4 and the display device 5, (d) denotes gradation data DL generated by the horizontal scanning circuit 51, and (e) denotes a counter clock signal CCLK generated by the timing generation circuit 2.

(f) denotes a gradation counter value QD generated by the horizontal scanning circuit 51, (g) denotes an all-pixel reset signal SELRST generated by the timing generation circuit 2, and (h) denotes a coincidence pulse signal AP generated by the horizontal scanning circuit 51. (i) denotes an example of a stepwise waveform signal VSTP generated by the stepwise waveform signal generation circuit 3, and (j) denotes two examples of a sampling period and a hold period in which the horizontal scanning circuit 51 samples and holds the stepwise waveform signal VSTP.

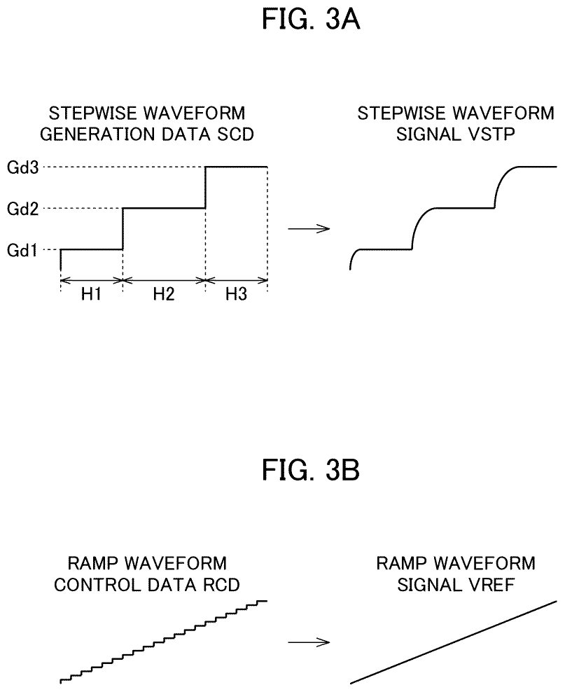

A typical display uses a ramp waveform signal VREF, which is an analog signal in which a voltage value rises from a black level to a white level, generated based on ramp waveform control data RCD, which is a digital signal in which a data value as illustrated in FIG. 3B sequentially increases within each horizontal scanning period. A typical display device applies to each pixel a voltage value determined by the ramp waveform signal VREF at a timing in which gradation data of each pixel coincides with a counter value in each horizontal scanning period.

In the display 1 according to one or more embodiments, the signal processing device 4 generates stepwise waveform generation data SCD, which is a digital signal in which a data value as illustrated in FIG. 3A increases stepwise. A stepwise waveform signal generation circuit 3 generates the stepwise waveform signal VSTP, which is an analog signal with a stepwise increase in voltage value, based on the stepwise waveform generation data SCD. Gd1 to Gd3 in the stepwise waveform generation data SCD indicate display gradations (pixel values) present within the horizontal scanning period, and H1 to H3 indicate time lengths corresponding to the number of pixels of the display gradation present within the horizontal scanning period. Here, a case is illustrated in which three pixel values of display gradations Gd1 to Gd3 are present within the horizontal scanning period.

The voltage does not rapidly become the voltage value corresponding to the display gradations Gd1 to Gd3 at the rise of the voltage in the stepwise waveform signal VSTP; the voltage becomes the voltage value corresponding to the display gradations Gd1 to Gd3 over a predetermined time at the rise of each step. A rate of change in a slope of voltage values at this point is called a slew rate. The time until the voltage falls within an allowable range of a voltage value (target value) corresponding to each display gradation at the rise of each step is determined by the slew rate, and the time is called a settling time. The display device 5 applies to each pixel an analog voltage value determined by the stepwise waveform signal VSTP at a timing when the gradation data of each pixel coincides with a counter value within a horizontal scanning period.

The video data VDS, which is digital data, the horizontal synchronization signal SHD, a vertical synchronization signal SVD, and a clock signal CLK, which are synchronized with the video data VDS, are input to the signal processing device 4. The signal processing device 4 transforms the input video data VDS into grayscale-transformed video data SVDS, and supplies the grayscale-transformed video data SVDS to the horizontal scanning circuit 51 of the display device 5. Details of how the signal processing device 4 transforms the video data VDS into grayscale-transformed video data SVDS will be described below.

The signal processing device 4 generates stepwise waveform generation data SCD for holding gradation data based on the video data VDS, the horizontal synchronization signal SHD, and the clock signal CLK, and supplies it to the stepwise waveform signal generation circuit 3. Specific examples of the configuration of the signal processing device 4 and a signal processing method executed by the signal processing device 4 will be described later.

The clock signal CLK, the horizontal synchronization signal SHD, and the vertical synchronization signal SVD are input to the timing generation circuit 2. The timing generation circuit 2 generates a counter clock signal CCLK, the counter reset signal CRST, a latch pulse signal SL, and the all-pixel reset signal SELRST based on the clock signal CLK and the horizontal synchronization signal SHD, and supplies them to the horizontal scanning circuit 51. The timing generation circuit 2 supplies a gradation counter clock signal ACLK to the stepwise waveform signal generation circuit 3. The timing generation circuit 2 generates a row selection signal VCK and a vertical reset signal VST based on the clock signal CLK, the horizontal synchronization signal SHD, and the vertical synchronization signal SVD, and supplies them to the vertical scanning circuit 52.

The stepwise waveform signal generation circuit 3 generates the stepwise waveform signal VSTP as illustrated in FIG. 3A based on the stepwise waveform generation data SCD and the gradation counter clock signal ACLK, and supplies it to the horizontal scanning circuit 51. The number of steps of the stepwise waveform signal VSTP is determined by the number of display gradations present in each horizontal scanning period, and the time length of each step is determined by the number of pixels of each display gradation.

The horizontal scanning circuit 51 is connected to the pixels 53 of the display pixel section 50 via column data lines D1 to Dx. For example, the column data line DI is connected to the y pixels 53 of a first column of the display pixel section 50. The column data line D2 is connected to the y pixels 53 of a second column of the display pixel section 50, and the column data line Dx is connected to the y pixels 53 of a x-th column of the display pixel section 50. The horizontal scanning circuit 51 includes a shift register 61, a latch circuit 62, a counter circuit 63, x comparator circuits 64 (641 to 64x), and x selection circuits 65 (651 to 65x).

The grayscale-transformed video data SVDS and the clock signal CLK are input to the shift register 61. Based on the clock signal CLK, the grayscale-transformed video data SVDS is sequentially input to the shift register 61 as the gradation data DL corresponding to the x pixels 53 of one of the row scanning lines G per unit of one horizontal scanning period.

The gradation data DL has m-bit gradation data. For example, when m=8 bits, the display device 5 can display 256 gradations for each of the pixels 53. The shift register 61 shifts m-bit gradation data which is sequentially input, in parallel. For example, when x=1920 in the display pixel section 50, corresponding to full high vision, the shift register 61 shifts the m-bit gradation data corresponding to each of the 1920 pixels 53 during one horizontal scanning period.

The latch pulse signal SL is input to the latch circuit 62 during a horizontal blanking period. The latch circuit 62 receives the gradation data DL corresponding to x pixels 53 of one of the row scanning lines G from the shift register 61 within one horizontal scanning period based on the latch pulse signal SL. The latch circuit 62 holds m-bit gradation data corresponding to each of the x pixels 53 that have been received for a next one horizontal scanning period.

The counter clock signal CCLK and the counter reset signal CRST are input from the timing generation circuit 2 to the counter circuit 63. The counter circuit 63 sequentially counts m-bit gradation counter values QD based on the counter clock signal CCLK. Thus, the counter circuit 63 supplies the gradation counter value QD (0 to (2m−1)) of 2m to the comparator circuits 64 (641 to 64x) every single horizontal scanning period. Therefore, the counter circuit 63 supplies the gradation counter value QD having the same number of gradations as the gradation data to each of the comparator circuits 64.

The comparator circuits 64 (641 to 64x) correspond to each of the column data lines D (D1 to Dx). The gradation counter value QD is input from the counter circuit 63 to each of the comparator circuits 64, and the gradation data DL corresponding to each of the pixels 53 is input from the latch circuit 62. Each of the comparator circuits 64 compares the gradation data DL and the gradation counter value QD for each bit, generates the coincidence pulse signal AP when both coincide, and supplies the coincidence pulse signal AP to the corresponding selection circuits 65.

The selection circuits 65 (651 to 65x) correspond to the comparator circuits 64 (641 to 64x). The selection circuits 65 (651 to 65x) are connected to the column data lines D (D1 to Dx). For example, the selection circuit 651 is connected to y pixels 53 in the first column of the display pixel section 50 via the column data line D1. The selection circuit 652 is connected to the y pixels 53 in the second column of the display pixel section 50 via the column data line D2, and the selection circuit 65x is connected to the y pixels 53 in the xth column of the display pixel section 50 via the column data line Dx.

Each of the selection circuits 65 receives the coincidence pulse signal AP from the corresponding comparator circuits 64. Each of the selection circuit 65 receives the stepwise waveform signal VSTP from the stepwise waveform signal generation circuit 3, and the all-pixel reset signal SELRST from the timing generation circuit 2.

The selection circuits 65 includes an analog switch for starting and ending sampling of the stepwise waveform signal VSTP. Each of the selection circuits 65 receives the all-pixel reset signal SELRST from the timing generation circuit 2 during one horizontal blanking period, thereby turning on each analog switch and starting sampling of the stepwise waveform signal VSTP, as illustrated in (j) of FIG. 2. Each of the selection circuits 65 turns off the analog switch at the rising timing of the coincidence pulse signal AP to end sampling, and holds the voltage value during the period of the coincidence pulse signal AP in the stepwise waveform signal VSTP.

(j) of FIG. 2 illustrates an example in which the coincidence pulse signal AP is generated in a second step within a certain horizontal scanning period, and the coincidence pulse signal AP is generated in the third step within the next horizontal scanning period. The selection circuits 65 hold the voltage value in the second step when the coincidence pulse signal AP is generated in the second step, and holds the voltage value in the third step when the coincidence pulse signal AP is generated in the third step. A sampling period is a period from when the selection circuits 65 start sampling the stepwise waveform signal VSTP until the fall of the coincidence pulse signal AP, and a hold period is a period from the fall of the coincidence pulse signal AP until the input of the all-pixel reset signal SELRST.

The selection circuits 65 supply the voltage value obtained by sampling the stepwise waveform signal VSTP based on the timing of the coincidence pulse signal AP to the corresponding column data lines D as a gradation drive voltage VID per unit of one horizontal scanning period.

The vertical scanning circuit 52 is connected to the pixels 53 of the display pixel section 50 via the row scanning lines G (G1 to Gy). For example, the row scanning line G1 is connected to the x pixels 53 of the first row of the display pixel section 50. The row scanning line G2 is connected to the x pixels 53 of the second row of the display pixel section 50, and the row scanning line Gy is connected to the x pixels 53 of the yth row of the display pixel section 50.

The vertical scanning circuit 52 receives the row selection signal VCK and the vertical reset signal VST from the timing generation circuit 2. The vertical scanning circuit 52 sequentially supplies the row selection signal VCK for sequentially selecting row scanning lines G (G1 to Gy) one by one per unit of one horizontal scanning period from the row scanning line G1 to the row scanning line Gy.

Each of the pixels 53 of the display pixel section 50 includes a pixel selection transistor 66 and a pixel driver 67. The pixel selection transistor 66 has a gate connected to the row scanning lines G, a drain connected to the column data lines D, and a source connected to the pixel driver 67. A thin film transistor may be used as the pixel selection transistor 66.

The pixel selection transistor 66 is subject to switching control based on the row selection signal VCK input from the vertical scanning circuit 52 via the row scanning lines G. When the pixel selection transistor 66 is turned on based on the row selection signal VCK, the gradation drive voltage VID is applied to the pixel driver 67.

The pixel driver 67 is driven based on the gradation drive voltage VID. Thus, each of the pixels 53 displays an image in gradation according to the voltage value of the gradation drive voltage VID to be applied. All the pixels 53 of the display pixel section 50 display images in gradation, the display device 5 can display the image of each frame in gradation.

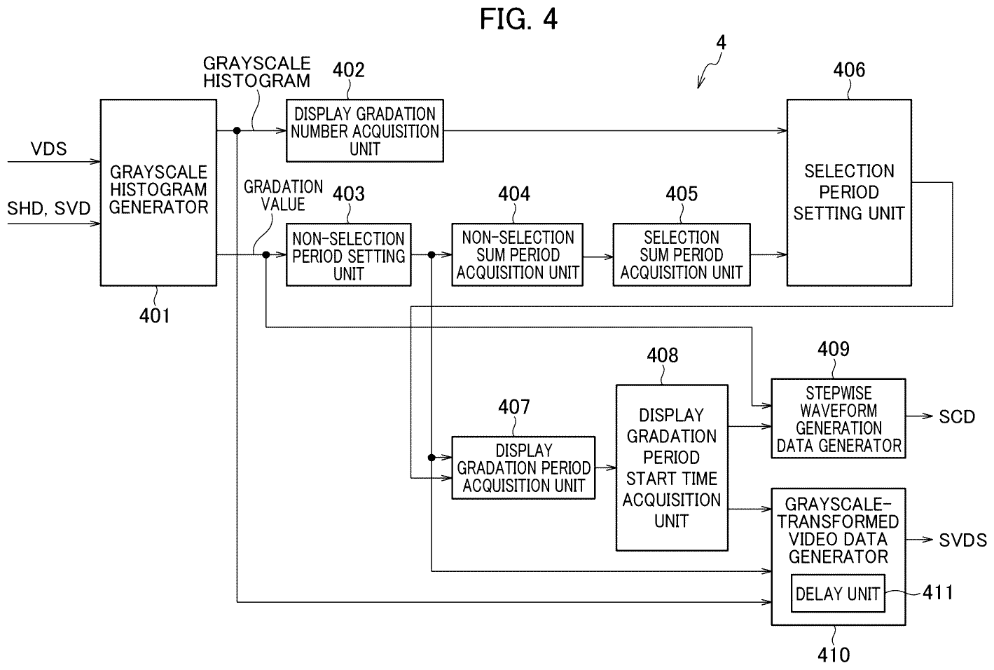

A specific configuration and an operation of the signal processing device 4 will be described with reference to FIG. 4. The signal processing device 4 includes a grayscale histogram generator 401, a display gradation number acquisition unit 402, a non-selection period setting unit 403, a non-selection sum period acquisition unit 404, a selection sum period acquisition unit 405, and a selection period setting unit 406. Further, the signal processing device 4 includes a display gradation period acquisition unit 407, a display gradation period start time acquisition unit 408, a stepwise waveform generation data generator 409, and a grayscale-transformed video data generator 410. The grayscale-transformed video data generator 410 includes a delay unit 411.

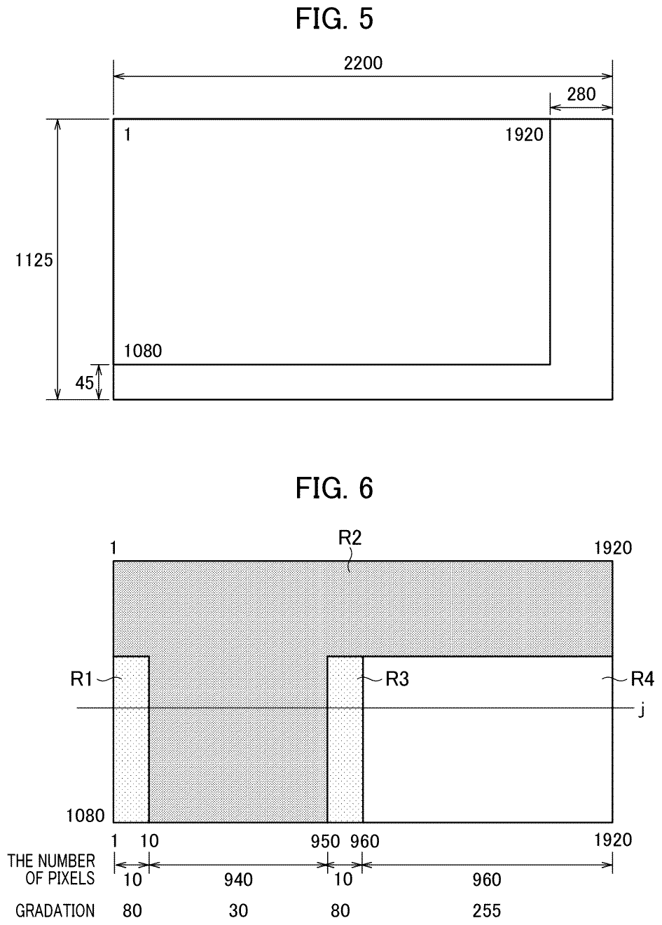

FIG. 5 illustrates the video format of the video data VDS input to the signal processing device 4. The video data VDS has an effective video period corresponding to the number of pixels of the display pixel section 50, of which the number of horizontal pixels is 1920 and the number of vertical pixels (number of vertical lines) is 1080. The number of horizontal pixels 1920 corresponds to 1920 counts of the counter clock signal CCLK. The 280 counts in the horizontal direction outside the effective video period are the horizontal blanking period. The 45 lines in the vertical direction outside the effective video period are a vertical blanking period.

Assume that a certain frame is an image as illustrated in FIG. 6. The frame illustrated in FIG. 6 has areas R1 and R3 of a gradation 80, area R2 of a gradation 30, and area R4 of a gradation 255. The gradations 80, 30, and 255 are display gradations. The operation of the signal processing device 4 during the horizontal scanning period of the line j in the frame illustrated in FIG. 6 will be described as an example. In the line j, areas R1 and R3 have 10 pixels, an area R2 has 940 pixels, and an area R4 has 960 pixels.

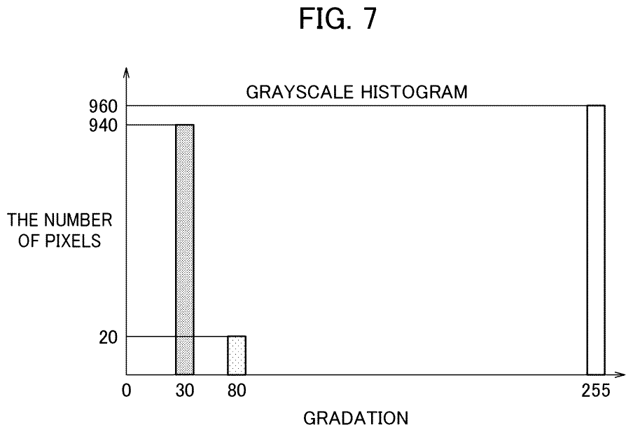

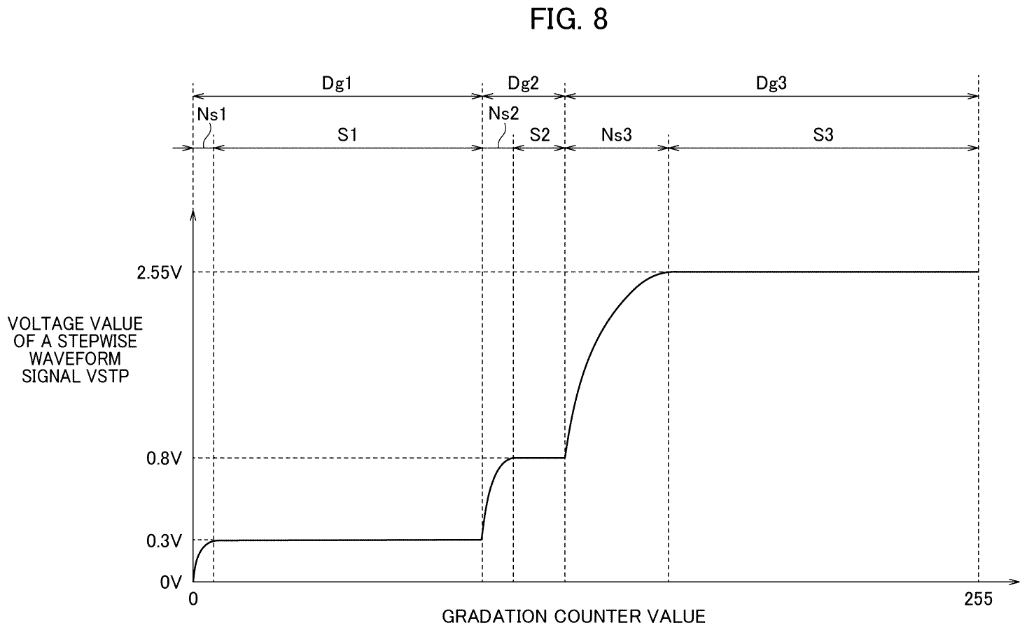

In FIG. 4, the grayscale histogram generator 401 generates a grayscale histogram indicating the number of pixels for each display gradation in each horizontal scanning period of the input video data VDS. FIG. 7 shows a grayscale histogram generated by the grayscale histogram generator 401 in the horizontal scanning period of the line j of the frame illustrated in FIG. 6. The display gradation is 3 in the line j of the frame illustrated in FIG. 6, as described with reference to FIG. 3A, the stepwise waveform signal VSTP may be a voltage waveform having three steps as illustrated in FIG. 8. It is assumed that the voltage value of the stepwise waveform signal VSTP is 0.3 V for the grayscale 30, 0.8 V for the grayscale 80, and 2.55 V for the grayscale 255.

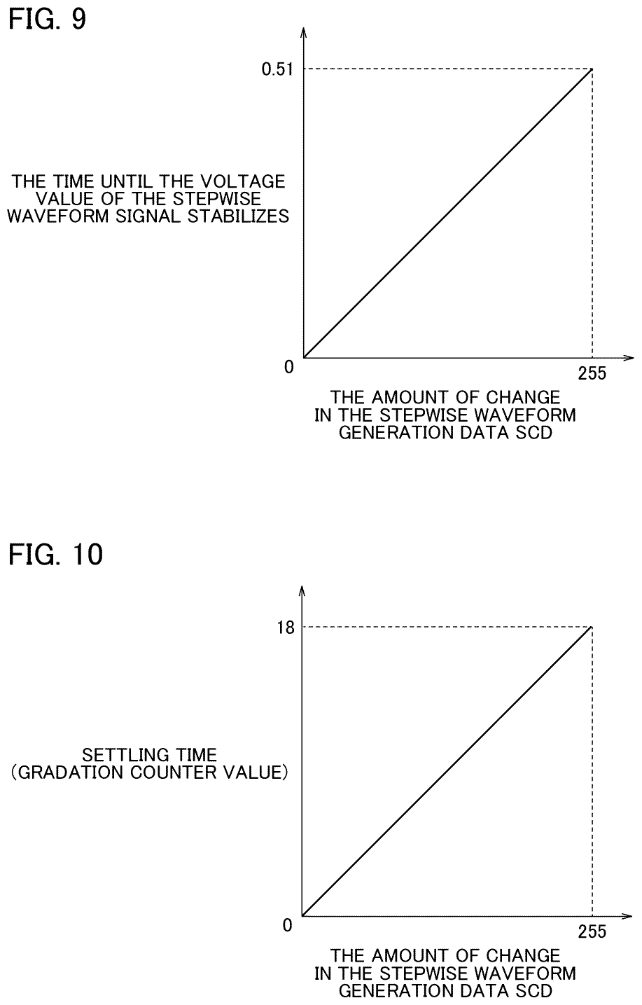

As described above, when the voltage of each step in the stepwise waveform signal VSTP rises, the voltage value rises to the voltage value corresponding to each display gradation over a settling time determined by the slew rate. As illustrated in FIG. 9, the time until the voltage value of the stepwise waveform signal VSTP stabilizes is proportional to an amount of change in the stepwise waveform generation data SCD. FIG. 10 illustrates a relationship between an amount of change in the stepwise waveform generation data SCD and the settling time when the settling time is converted to a count value of the gradation counter clock signal ACLK. The settling time is proportional to the amount of change in the stepwise waveform generation data SCD. Thus, the settling time is determined by the slew rate characteristic corresponding to the amount of change in the stepwise waveform generation data SCD.

In FIG. 4, a grayscale histogram generated by the grayscale histogram generator 401 is input to the display gradation number acquisition unit 402. The display gradation number acquisition unit 402 acquires the display gradation number based on the grayscale histogram that has been input. Here, the display gradation number acquisition unit 402 acquires “3” as the display gradation number. The display gradation number acquisition unit 402 supplies the grayscale histogram and the display gradation number to the selection period setting unit 406.

A gradation value based on the grayscale histogram generated by the grayscale histogram generator 401 is input to the non-selection period setting unit 403. Here, the gradations 30, 80, and 255 are input as gradation values to the non-selection period setting unit 403. The signal processing device 4 generates the stepwise waveform generation data SCD which is a stepwise waveform of a digital signal, and the stepwise waveform signal generation circuit 3 generates the stepwise waveform signal VSTP which is an analog signal based on the stepwise waveform generation data SCD. Therefore, although the stepwise waveform signal VSTP is not generated at the time of signal processing by the signal processing device 4, the non-selection period setting unit 403 sets a non-selection period within the total number of grayscales of each horizontal scanning period as follows on the assumption that the stepwise waveform signal VSTP is generated as a result, based on the stepwise waveform generation data SCD. Here, the total number of gradations is 256.

As illustrated in FIG. 8, the non-selection period setting unit 403 sets non-selection periods Ns1 to Ns3 corresponding to display gradations within the total number of gradations of the stepwise waveform signal VSTP, generated based on the grayscale histogram and having each display gradation present in each horizontal scanning period, and a time length corresponding to the number of pixels of each display gradation within each horizontal scanning period. The non-selection periods Ns1 to Ns3 are based on settling time from the start time of the latest step when the voltage value of the stepwise waveform signal VSTP corresponding to each display gradation increases stepwise from the previous step to the latest step until the voltage value of the latest step falls within an allowable range of a target value. The non-selection period setting unit 403 supplies the non-selection periods Ns1 to Ns3 to the non-selection sum period acquisition unit 404 and to the display gradation period acquisition unit 407.

Although the stepwise waveform signal VSTP is not generated in the signal processing device 4, FIG. 8 illustrates the stepwise waveform signal VSTP so that the non-selection periods Ns1 to Ns3 based on the settling time can be easily understood. In the first step, the gradation increases from gradation 0 to a display gradation 30. In the next step, the display gradation increases from the display gradation 30 to a display gradation 80, and in the next step, the display gradation increases from the display gradation 80 to a display gradation 255. Referring to FIG. 10, the non-selection period setting unit 403 sets the non-selection periods Ns1 to Ns3 represented by the gradation counter value by the clock signal CLK having a relationship Ns1<Ns2<Ns3.

The non-selection periods Ns1 to Ns3 may be the same period as the settling time, or may be a period slightly longer than the settling time. The non-selection periods Ns1 to Ns3 may be determined based on the settling time.

The non-selection sum period acquisition unit 404 acquires a non-selection sum period obtained by summing up the non-selection periods Ns1 to Ns3. The selection sum period acquisition unit 405 acquires a selection sum period obtained by subtracting the non-selection sum period from the total number of gradations. In FIG. 8, the time obtained by summing up selection periods S1, S2, and S3 is a selection sum period. Note that, at the time when the non-selection sum period acquisition unit 404 acquires the selection sum period, only the total time of the selection periods S1, S2, and S3 is obtained, and the selection periods S1, S2, and S3 are not determined. The selection sum period acquisition unit 405 supplies the selection sum period to the selection period setting unit 406.

The selection period setting unit 406 sets the selection periods S1 to S3 corresponding to the display gradations following the non-selection periods Ns1 to Ns3 corresponding to the display gradations within the total number of gradations, based on the grayscale histogram and the selection sum period. Preferably, the selection periods S1 to S3 have a time length corresponding to the number of pixels of display gradations. The selection sum period is based on the non-selection sum period, and the selection period setting unit 406 sets the selection periods S1 to S3 based on the grayscale histogram, the non-selection sum period, and the selection sum period. The selection period setting unit 406 sets the selection periods S1 to S3 by dividing the selection sum period by the time corresponding to the number of pixels of each display gradation. The selection period setting unit 406 supplies the selection periods S1 to S3 to the display gradation period acquisition unit 407.

The display gradation period acquisition unit 407 acquires display gradation periods Dg1 to Dg3 obtained by combining the non-selection periods Ns1 to Ns3 and the selection periods S1 to S3 corresponding to the display gradations. The display gradation period start time acquisition unit 408 acquires the start times of the display gradation periods Dg1 to Dg3 for the display gradations from the lowest display gradation (the display gradation 30 in this case) to the highest display gradation (the display gradation 255 in this case) present in each horizontal scanning period based on the display gradation periods Dg1 to Dg3. The start time of the display gradation period Dg1 is the time corresponding to the gradation counter value 0. The start time of the display gradation period Dg2 is the end time of the display gradation period Dg1. The start time of the display gradation period Dg3 is the time at which the accumulated time of the display gradation period Dg1 and the display gradation period Dg2 has elapsed.

When the display gradation period start time acquisition unit 408 acquires the start time of the display gradation period of the display gradation after a third step, it is sufficient to accumulate the display gradation periods of the display gradation up to an immediately preceding step.

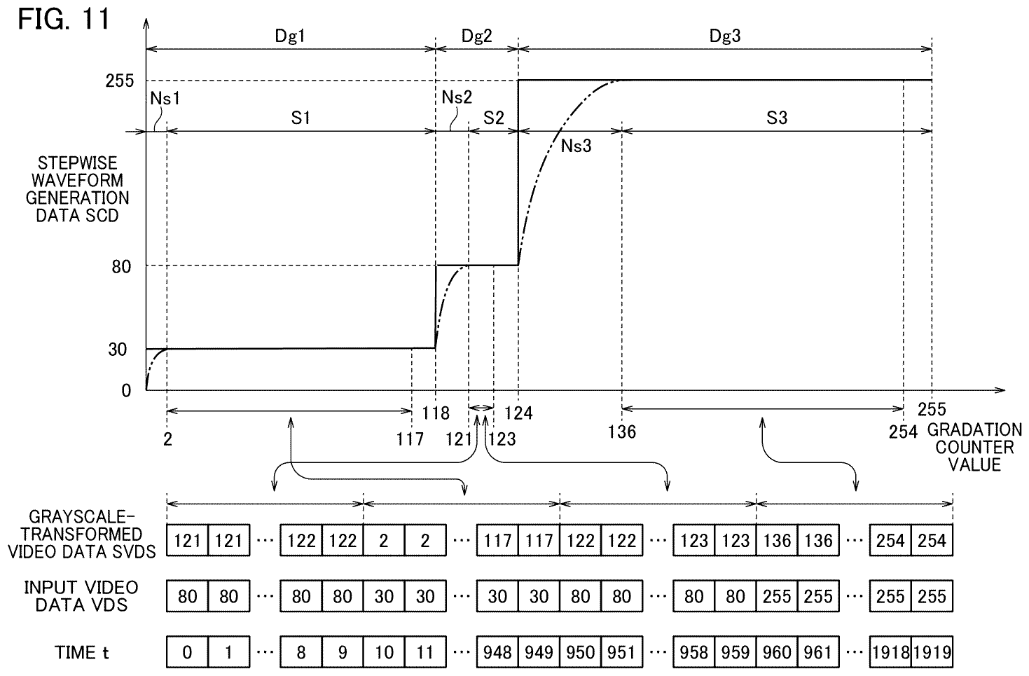

The stepwise waveform generation data generator 409 generates the stepwise waveform generation data SCD illustrated in FIG. 11 for generating the stepwise waveform signal VSTP on the basis of the gradation value of each display gradation and the start time of the display gradation periods Dg1 to Dg3 for each display gradation. The stepwise waveform generation data SCD has steps of data values corresponding to each display gradation within each horizontal scanning period. The data values for obtaining the graduations 30, 80, and 255 are 30, 80, and 255, respectively. Each step in the stepwise waveform generation data SCD preferably has a time length corresponding to the number of pixels of each display gradation.

The grayscale-transformed video data generator 410 generates the grayscale-transformed video data SVDS which is video data obtained by transforming the pixel values (a plurality of identical pixel values) of the pixels constituting each display gradation in each horizontal scanning period of the video data VDS into pixel values that are dispersed so as to correspond to the selection periods S1 to S3 in the display gradation periods Dg1 to Dg3 corresponding to the display gradations.

The grayscale-transformed video data generator 410 receives a grayscale histogram in progress that is obtained in order as pixels progress from the first pixel of one line. The number of pixels having the same pixel value is known from the grayscale histogram finally obtained at the end of one line. Therefore, the grayscale-transformed video data generator 410 determines intervals at which the plurality of pixel values are arranged in the selection periods S1 to S3 based on the grayscale histogram finally obtained at the end of one line. The delay unit 411 delays the grayscale histogram in progress. The grayscale-transformed video data generator 410 sequentially arranges the same pixel values based on the grayscale histogram in progress at predetermined intervals.

As illustrated in FIGS. 6 and 11, the gradation of the ten pixels from the first pixel to the tenth pixel, and from the 951st pixel to the 960th pixel of the line j is 80. The grayscale-transformed video data generator 410 arranges the twenty pixels having the pixel values 80 from the first pixel to the tenth pixel, and from the 951st pixel to the 960th pixel of the line j in a dispersed manner as pixels having a plurality of pixel values at the timing within the selection period S2 which is the step of the gradation 80. The same pixel values, such as the pixel values 121, 122, and 123, are present in the grayscale-transformed video data SVDS, since the 1920 pixels are dispersed based on the gradation counter value of 256.

The gradation of the 940 pixels from the eleventh pixel to the 950th pixel of the line j is 30. The grayscale-transformed video data generator 410 arranges the 940 pixels having the pixel value 30 from the eleventh pixel to the 950th pixel of the line j in a dispersed manner as pixels having a plurality of pixel values in the timing within the selection period S1 which is the step of the gradation 30. The display gradation of the 960 pixels from the 961st pixel to the 1920th pixel of the line j is 255. The grayscale-transformed video data generator 410 arranges the 960 pixels having the pixel value 30 from the 961st pixel to the 1920th pixel of the line j in a dispersed manner as pixels having a plurality of pixel values in the timing within the selection period S3 which is the step of the display gradation 255.

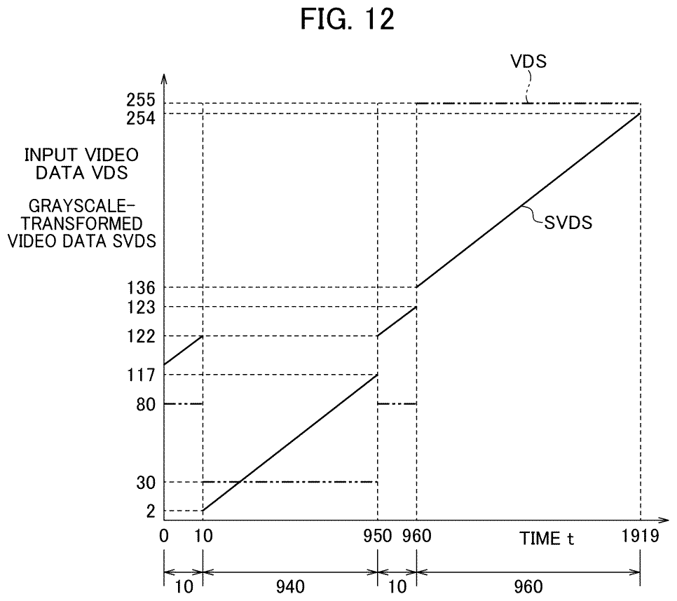

As described above, the grayscale-transformed video data generator 410 transforms gradations in the video data VDS to generate the grayscale-transformed video data SVDS. As a result, when the horizontal axis is the time t, and the vertical axis is the pixel values of the video data VDS and the grayscale-transformed video data SVDS, FIG. 12 illustrates how the pixel values change with the progress of the time t. In the grayscale-transformed video data SVDS, the pixel values increase linearly in sequence.

As described above, in FIG. 1, when the gradation data DL and the gradation counter value QD coincide, the comparator circuits 64 supply the coincidence pulse signal AP to the corresponding selection circuits 65. As illustrated in FIGS. 11 and 12, the same pixel values in the video data VDS are replaced by pixels having a plurality of pixel values in the grayscale-transformed video data SVDS in consecutive periods. Therefore, the timing of the coincidence pulse signal AP input to the selection circuits 65 is dispersed, and it is possible to avoid that many analog switches of the selection circuits 65 are simultaneously turned off. Many analog switches are not simultaneously turned off, so that the load fluctuation generated in the stepwise waveform signal VSTP illustrated in FIG. 8 is small, and ringing rarely occurs.

Although consecutive identical pixel values in the video data VDS are replaced by pixels having a plurality of pixel values in the grayscale-transformed video data SVDS, the image of each frame displayed on the display pixel section 50 is the same as the image displayed using the video data VDS. This is because the selection circuits 65 supply a voltage value determined based on the stepwise waveform signal VSTP as the gradation drive voltage VID to the corresponding column data lines D, instead of the voltage value determined based on the ramp waveform signal VREF illustrated in FIG. 3B.

As described above, according to the signal processing device 4, the signal processing method executed by the signal processing device 4, and the display 1 including the signal processing device 4, the occurrence of ringing itself can be suppressed, and the gradation reproducibility can be further improved. According to the signal processing device 4, the signal processing method executed by the signal processing device 4, and the display 1 including the signal processing device 4, even if the ringing period relative to the horizontal scanning period becomes relatively long due to the display 1 displaying video data of a high frame rate, the occurrence of ringing itself can be suppressed, so that the gradation reproducibility rarely deteriorates.

The components of the signal processing device 4 illustrated in FIG. 4 may be constituted by hardware or software. In the former case, the components of the signal processing device 4 may be constituted by an integrated circuit, a field programmable gate array (FPGA), or a programmable logic 5 device (PLD).

The present invention is not limited to one or more embodiments described above, and various modifications may be made without departing from the scope of the present invention.

What is claimed is:

1. A signal processing device comprising:
a grayscale histogram generator configured to generate a grayscale histogram indicating the number of pixels for each display gradation in horizontal scanning periods of input video data;
a non-selection period setting unit configured to set a non-selection period corresponding to the display gradations in a stepwise waveform signal, which is an analog signal with a stepwise increase in voltage value in accordance with the display gradations present within the horizontal scanning periods, based on settling time from a start time of each step when the voltage value corresponding to the display gradations increases stepwise until the voltage value of each step falls within an allowable range of a target value;
a selection period setting unit configured to set a selection period corresponding to the display gradations following the non-selection period, based on the grayscale histogram, a non-selection sum period obtained by summing up the non-selection periods corresponding to the display gradations in the horizontal scanning periods, and a selection sum period obtained by subtracting the non-selection sum period from the total number of gradations of the video data;
a display gradation period start time acquisition unit configured to acquire a start time of a display gradation period which is a period obtained by combining the non-selection period and the selection period, for each of the display gradations based on the display gradation period;
a stepwise waveform generation data generator configured to generate stepwise waveform generation data for generating the stepwise waveform signal, based on gradation values of the display gradations and start time of the display gradation period for each of the display gradations; and
a grayscale-transformed video data generator configured to generate grayscale-transformed video data, which is video data obtained by transforming pixel values of each pixel in the horizontal scanning periods of the video data into pixel values that are dispersed so as to correspond to the selection periods corresponding to the display gradations.

2. The signal processing device according to claim 1, wherein
the selection period setting unit is configured to set the selection period corresponding to the display gradations having a time length corresponding to the number of pixels of the display gradations; and
the stepwise waveform generation data generator is configured to generate stepwise waveform generation data having a time length corresponding to the number of pixels of the display gradations.

3. A display comprising:
a signal processing device according to claim 1;
a stepwise waveform signal generation circuit configured to generate the stepwise waveform signal by converting the stepwise waveform generation data into an analog signal; and
a display device having a plurality of pixels and configured to generate a gradation drive voltage for each of the pixels, based on the grayscale-transformed video data and the stepwise waveform signal.

4. A signal processing method comprising:
generating a grayscale histogram indicating the number of pixels for each display gradation in horizontal scanning periods of input video data;
setting a non-selection period corresponding to the display gradations in a stepwise waveform signal, which is an analog signal with a stepwise increase in voltage value in accordance with display gradations present within the horizontal scanning periods, based on settling time from a start time of each step when the voltage value corresponding to the display gradations increases stepwise until the voltage value of each step falls within an allowable range of a target value;
setting a selection period corresponding to the display gradations following the non-selection period, based on the grayscale histogram, a non-selection sum period obtained by summing up the non-selection periods corresponding to the display gradations in the horizontal scanning periods, and a selection sum period obtained by subtracting the non-selection sum period from the total number of gradations of the video data;
acquiring a start time of a display gradation period which is a period obtained by combining the non-selection period and the selection period, for each of the display gradations based on the display gradation period; and
generating grayscale-transformed video data, which is video data obtained by transforming pixel values of each pixel in the horizontal scanning periods of the video data into pixel values that are dispersed so as to correspond to the selection periods corresponding to the display gradations.
